(19) United States
(12) Patent Application Publication
(10) Pub. No.: US 2008/0278364 A1
(43) Pub. Date: Nov. 13, 2008

(54) System for communication and control and method thereof

(75) Inventor: Shien-Jen Ho, Taoyuan County (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 11/902,429

(22) Filed: Sep. 21, 2007

(30) Foreign Application Priority Data
May 8, 2007 (TW) 096116349

(51) Int. Cl. G08C 19/12

(52) U.S. Cl. 341/176

(57) ABSTRACT

A system for communication and control is provided. The system for communication and control includes a remote controller and a first controlled device. The remote controller is for outputting a broadcast signal, a lock signal and a control signal. The first controlled device is for receiving the broadcast signal and outputting a first magnitude signal to the remote controller according to the magnitude of the received broadcast signal. The remote controller, in response to the first magnitude signal, outputs the lock signal to lock the first controlled device and outputs the control signal to control the first controlled device.

This application claims the benefit of Taiwan application Serial No. 96116349, filed May 8, 2007, the subject matter of which is incorporated herein by reference.

### BACKGROUND OF THE INVENTION

1. Field of the Invention

The invention relates in general to a system for communication and control, and more particularly to a system for communication and control capable of simplifying operating procedure for a user.

2. Description of the Related Art

Along with the advance in technology, many electronic appliances such as TV, video/DVD player and recorder are equipped with a remote controller for the user's convenience in operation. However, the remote controller is exclusive to only one particular electronic appliance. Sometimes, when the user would like to use a remote controller to control one of the electronic appliances, the user may even be confused by so many different remote controllers and do not know which one to choose.

Furthermore, the electronic appliances may be manufactured by different manufacturers, and the remote controllers for different electronic appliances may use different control signals. Let the universal remote controller capable of controlling various electronic appliances be taken for example. When the user uses the universal remote controller, the control interface of the universal remote controller must be switched to the target electronic appliance first before the corresponding control signal can be outputted. Thus, how to develop a system for communication and control to facilitate the user's operation has become an imminent issue to be resolved.

### SUMMARY OF THE INVENTION

The invention is directed to a system for communication and control. According to the system for communication and control, the user can lock and control one among a number of controlled devices by directing one remote controller towards the target controlled device.

According to a first aspect of the present invention, a system for communication and control is provided. The system for communication and control includes a remote controller and a first controlled device. The remote controller is for outputting a broadcast signal, a lock signal and a control signal. The first controlled device is for receiving the broadcast signal and outputting a first magnitude signal to the remote controller according to the magnitude of the received broadcast signal. The remote controller, in response to the first magnitude signal, outputs the lock signal to lock the first controlled device and outputs the control signal to control the first controlled device.

According to a second aspect of the present invention, a method for communication and control used in a system for communication and control is provided. The system for communication and control includes a remote controller and a first controlled device. The method for communication and control includes the following steps. Firstly, the remote controller outputs a broadcast signal to the first controlled device. Next, the first controlled device receives the broadcast signal and outputs a first magnitude signal to the remote controller according to the magnitude of the received broadcast signal. Then, the remote controller, in response to the first magnitude signal, outputs a lock signal to lock the first controlled device and outputs a control signal to control the first controlled device.

The invention will become apparent from the following detailed description of the preferred but non-limiting embodiments. The following description is made with reference to the accompanying drawings.

### BRIEF DESCRIPTION OF THE DRAWINGS

FIG. 1 is a system for communication and control according to an embodiment of the invention;

FIG. 2 is a time sequence diagram of movement when a user operates the system for communication and control according to an embodiment of the invention; and

FIG. 3 is a method for communication and control according to an embodiment of the invention.

### DETAILED DESCRIPTION OF THE INVENTION

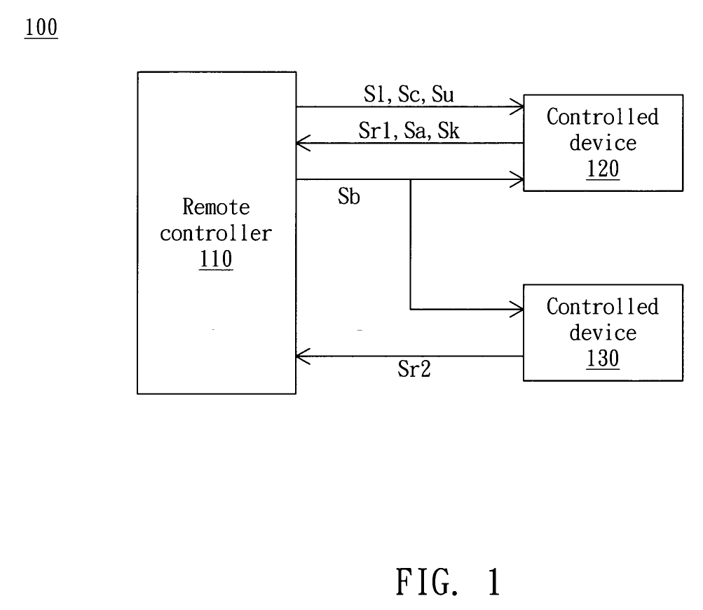

FIG. 1 is a system for communication and control 100 according to an embodiment of the invention. The system for communication and control 100 includes a remote controller 110 and a controlled device 120. The remote controller 110 is for outputting a broadcast signal Sb, a lock signal Sl and a control signal Sc. The controlled device 120 is for receiving the broadcast signal Sb and outputting a magnitude signal Sr1 to the remote controller 110 according to the magnitude of the received broadcast signal Sb.

The remote controller 110, in response to magnitude signal Sr1, outputs the lock signal Sl to lock the controlled device 120 and outputs the control signal Sc to control the controlled device 120.

After the controlled device 120 receives the lock signal Sl and is locked accordingly, the controlled device 120 outputs a lock confirmation signal Sa to the remote controller 110 to inform the remote controller 110 that the controlled device 120 is locked. The remote controller 110 receives the lock confirmation signal Sa and accordingly outputs the control signal Sc to control the controlled device 120.

The controlled device 120 further outputs a visual response signal (not illustrated) such as an indicating lamp signal to inform the user that the controlled device 120 is locked.

The system for communication and control 100 further includes a controlled device 130. The controlled device 130 also receives the broadcast signal Sb emitted by the remote controller 110 and outputs a magnitude signal Sr2 to the remote controller 110 according to the magnitude of the received broadcast signal Sb.

The remote controller 110, according to the received magnitude signals Sr1 and Sr2, determines which one of the controlled devices 120 and 130 receives the broadcast signal Sb having stronger magnitude, and outputs the lock signal Sl to lock either of the controlled devices 120 and 130 receiving the broadcast signal Sb having stronger magnitude and outputs the control signal Sc the control the locked controlled devices.

For example, when the remote controller 110, according to the magnitude signals Sr1 and Sr2, decides that the controlled device 120 receives a broadcast signal Sb having stronger magnitude, the remote controller 110 outputs the lock signal Sl to the controlled device 120 and locks the controlled device 120 accordingly.

After the controlled device 120 receives the lock signal Sl and outputs the lock notice signal Sa to the remote controller 110 accordingly, the remote controller 110 outputs the control signal Sc to control the locked controlled device 120.

The remote controller 110 includes an input interface (not illustrated). The user inputs a control instruction through the input interface, then the remote controller 110 outputs the control signal Sc accordingly.

In the present embodiment of the invention, all controlled devices are controlled by only one remote controller. The remote controller uses the control signals of the same communication protocol to control all of the controlled devices. For example, if the control signal for “playing the device” is 0x5A, then all the control signals 0x5A received by the controlled device are interpreted as “playing the device”.

The remote controller 110 locks the controlled device 120 before the remote controller 110 outputs the control signal Sc. Thus, even all controlled devices receive the control signal Sc, only the locked controlled device 120 will function according to the control signal Sc.

After the remote controller 110 stops controlling the controlled device 120, the remote controller 110 outputs the unlock confirmation signal Su to unlock the controlled device 120. After the controlled device 120 receives the unlock confirmation signal Su, the controlled device 120 emits the unlock notice signal Sk to inform the remote controller 110 of having been unlocked. Then, when the remote controller 110 emits the broadcast signal again, the controlled devices 120 and 130 are controlled in the same manner.

The remote controller 110 further includes a movement sensor (not illustrated) such as an accelerometer. After the movement sensor detects that the remote controller 110 is moved, then the remote controller 110 outputs the broadcast signal Sb.

The remote controller 110 preferably includes a wide-angle emitter and a narrow-angle emitter (both are not illustrated). The wide-angle emitter emits the broadcast signal Sb at a wide angle, such that all the controlled devices within the coverage of radiation can receive the broadcast signal Sb. The narrow-angle emitter emits the lock signal Sl and the control signal Sc at a narrow angle, such that the target controlled device can be precisely locked and controlled.

In the present embodiment of the invention, all signals are exemplified by an infra-red signal.

In the present embodiment of the invention, two controlled devices 120 and 130 are used. However, in practical application, the number of controlled devices used in the system for communication and control is not limited. The control method for controlling the controlled device remains the same and is not repeated here.

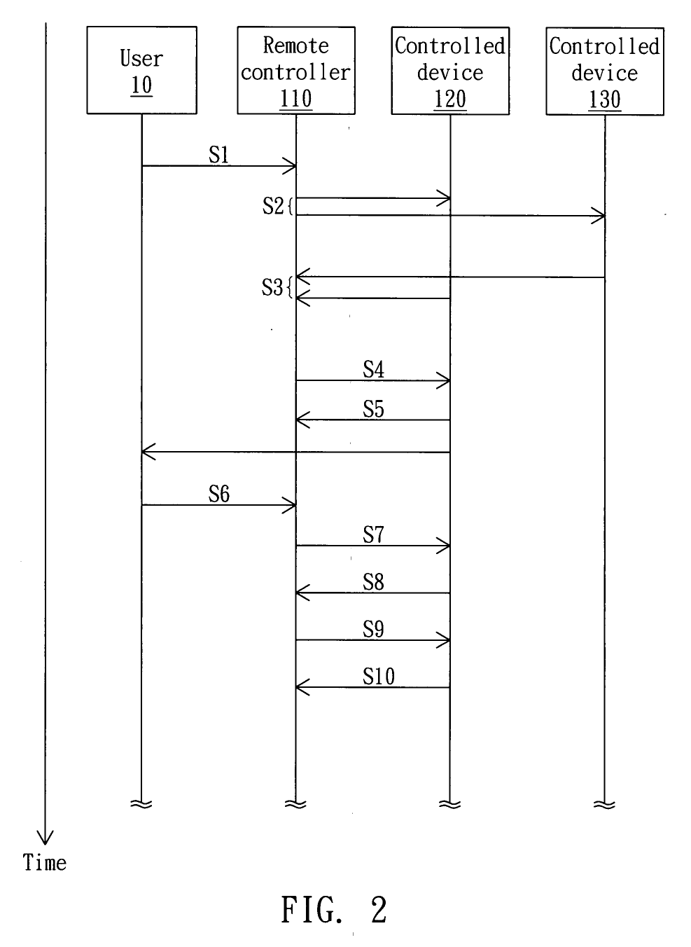

FIG. 2 is a time sequence diagram of movement when a user operates the system for communication and control 100 according to an embodiment of the invention. The time sequence S1 to S10 are arranged according to time sequence, wherein the time sequence S1 comes first and the time sequence S10 comes last. In FIG. 2, the user 10 controls one of the controlled devices 120 and 130 by the remote controller 110. Firstly, at the time sequence S1, the user 10 grabs and directs the remote controller 110 towards the target controlled device, that is, one of the controlled devices 120 and 130. Then, at the time sequence S2, after the accelerometer inside the remote controller 110 detects that the remote controller 110 is moved, the remote controller 110 immediately outputs the broadcast signal Sb to the controlled devices 120 and 130.

At the time sequence S3, the controlled devices 120 and 130 respectively output the magnitude signals Sr1 and Sr2 to the remote controller 110 according to the received magnitude of the broadcast signal Sb. The remote controller 110 determines which of the controlled devices 120 and 130 receives the broadcast signal Sb having stronger magnitude according to the magnitude signals Sr1 and Sr2. When the user 10 would like to control the controlled device 120, the user only needs to direct the remote controller 110 towards the controlled device 120 and enables the controlled device 120 to receive the broadcast signal Sb having stronger magnitude. According to the comparison of the magnitude signals Sr1 and Sr2, the remote controller 110 determines that the magnitude of the broadcast signal Sb received by the controlled device 120 is stronger than that received by the controlled device 130, and accordingly determines the controlled device 120 as the target controlled device that the user 10 desires to control.

Besides, in the remote controller 110, the broadcast signal Sb is outputted by a wide-angle emitter at a wide angle, such that all the controlled devices within the wide-angle coverage of radiation oriented towards the remote controller 110 can receive the broadcast signal Sb. Thus, the user can easily remote control the target controlled device without having to precisely direct the remote controller towards the target controlled device.

At the time sequence S4, the remote controller 110 outputs the lock signal Sl to the controlled device 120 to lock the controlled device 120. At the time sequence S5, the controlled device 120 outputs the lock confirmation signal Sa to the remote controller 110 and outputs a visual response signal such as an indicating lamp signal.

The user 10 determines whether the target controlled device is locked correctly according to the visual response signal. If the target controlled device is not locked correctly, the user 10 can adjust the orientation of the remote controller 110 until the target controlled device is locked correctly.

At the time sequence S6, the user 10 inputs a control instruction such as “playing the device” through an input interface of the remote controller 110. At the time sequence S7, the remote controller 110 outputs the control signal Sc to the controlled device 120, wherein the control signal Sc corresponds to the control instruction inputted by the user 10. At the time sequence S8, the controlled device 120 performs the instruction corresponding to the control signal Sc and outputs a confirmation signal (not illustrated) to the remote controller 110 to inform the remote controller 110 that the control signal Sc is received.

At the time sequence S9, the remote controller 110 outputs the unlock confirmation signal Sl to unlock the controlled device 120. At the time sequence S10, the controlled device 120 outputs the unlock confirmation signal Sk to the remote controller 110 to inform the remote controller 110 of the unlocking. Thus, the user 10 controls the controlled device 120 through the remote controller 110.

As indicated in FIG. 2, by using the system for communication and control 100 of the present embodiment of the invention, the user 10 can control any one of the controlled devices by grabbing and directing the remote controller 110 towards the target controlled device and inputting a control instruction. Thus, the system for communication and control of the present embodiment of the invention largely simplifies the complicated procedures of remote controlling a number of controlled devices such that the user can remote control a controlled device in an instinct manner.

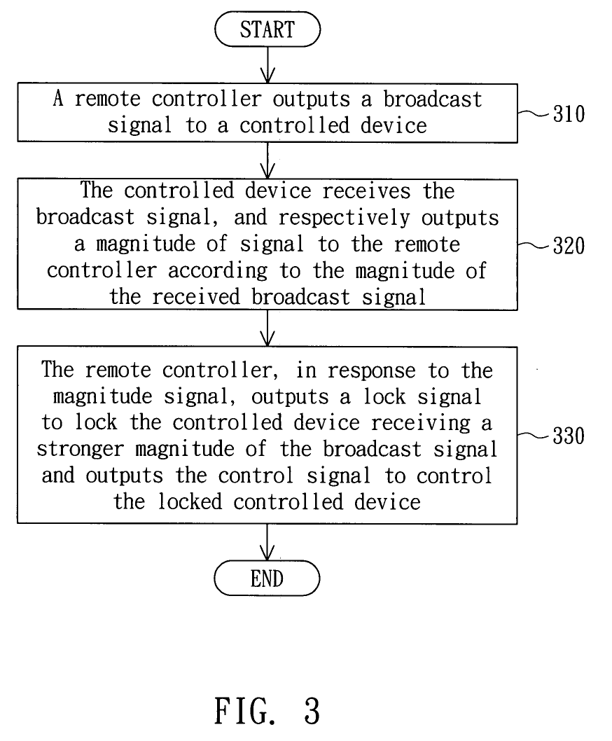

FIG. 3 is a method for communication and control according to an embodiment of the invention used in the system for communication and control 100. The method for communication and control includes the following steps. Firstly, the method begins at step 310, the remote controller 110 outputs a broadcast signal Sb to the controlled devices 120 and 130. Next, the method proceeds to step 320, the controlled devices 120 and 130 receive the broadcast signal Sb, and respectively output the magnitude of signals Sr1 and Sr2 to the remote controller 110 according to the magnitude of the received broadcast signal Sb. Then, the method proceeds to step 330, the remote controller 110, in response to the magnitude signals Sr1 and Sr2, outputs a lock signal Sl to lock the controlled device receiving a broadcast signal having stronger magnitude Sb and outputs the control signal Sc to control the locked controlled device.

According to the device for communication and control disclosed in the present embodiment of the invention, the remote controller determines the targeted controlled device that a user desires to control according to the magnitude of the broadcast signal received by the controlled device, and locks and controls the controlled device accordingly. The user can lock and control one among a number of controlled devices by directing one remote controller towards the target controlled device.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A system for communication and control, comprising:
a remote controller for outputting a broadcast signal, a lock signal and a control signal; and
a first controlled device for receiving the broadcast signal and outputting a first magnitude signal to the remote controller according to the magnitude of the received broadcast signal,
wherein the remote controller, in response to the first magnitude signal, outputs the lock signal to lock the first controlled device and outputs the control signal to control the first controlled device.

2. The system for communication and control according to claim 1, wherein the remote controller outputs the control signal after the first controlled device receives the lock signal and accordingly outputs a lock confirmation signal to the remote controller.

3. The system for communication and control according to claim 1, further comprises a second controlled device for receiving the broadcast signal and outputting a second magnitude signal to the remote controller according to the magnitude of the received broadcast signal;
wherein the remote controller, according to the first and the second magnitude signal, outputs the lock signal to lock either of the first and the second controlled device receiving the broadcast signal having stronger magnitude and outputs the control signal to control the locked controlled device.

4. The system for communication and control according to claim 3, wherein the remote controller further outputs an unlock confirmation signal to unlock the locked controlled device after the remote controller stops controlling the locked controlled device.

5. The system for communication and control according to claim 1, wherein the remote controller further outputs an unlock confirmation signal to unlock the first controlled device after the remote controller stops controlling the first controlled device.

6. The system for communication and control according to claim 5, wherein the first controlled device further outputs an unlock confirmation signal to the remote controller to inform the remote controller of being unlocked after the first controlled device receives the unlock confirmation signal.

7. The system for communication and control according to claim 1, wherein the remote controller further comprises a movement sensor for detecting whether the remote controller is moved, and the remote controller outputs the broadcast signal after the remote controller is moved.

8. The system for communication and control according to claim 1, wherein the remote controller further comprises a wide-angle emitter for emitting the broadcast signal at a wide angle.

9. The system for communication and control according to claim 1, wherein the remote controller further comprises a narrow-angle emitter for emitting the lock signal at a narrow angle.

10. The system for communication and control according to claim 1, wherein the remote controller comprises an input interface, after a user inputs a control instruction through the input interface, the remote controller outputs the control signal according to the control instruction.

11. The system for communication and control according to claim 1, wherein the first controlled device further outputs a visual response signal to inform a user after the first controlled device is locked.

12. A method for communication and control used in a system for communication and control, wherein the system for communication and control comprises a remote controller and a first controlled device, the method for communication and control comprises:
outputting a broadcast signal to the first controlled device by the remote controller;
receiving the broadcast signal and outputting a first magnitude signal to the remote controller according to the magnitude of the received broadcast signal by the first controlled device; and
outputting the lock signal to lock the first controlled device in response to the first magnitude signal, and outputting the control signal to control the first controlled device by the remote controller.

13. The method for communication and control according to claim 12, wherein the system for communication and control further comprises a second controlled device and in the step of outputting the broadcast signal output a broadcast signal to the first controlled device and the second controlled device by the remote controller.

14. The method for communication and control according to claim 13, wherein the method for communication and control further comprises:
receiving the broadcast signal and outputting a second magnitude signal to the remote controller according to the magnitude of the received broadcast signal by the second controlled device.

15. The method for communication and control according to claim 14, wherein in the step of outputting the lock signal and the control signal by the remote controller,output the lock signal to lock either of the first and the second controlled device receiving the broadcast signal having stronger magnitude according to the first and the second magnitude signal and outputting the control signal to control the locked controlled device.

16. The method for communication and control according to claim 12, wherein the method for communication and control further comprises:
stopping controlling the first controlled device and outputting an unlock confirmation signal by the remote controller to unlock the first controlled device.

17. The method for communication and control according to claim 16, wherein the method for communication and control further comprises:
outputting an unlock confirmation signal by the first controlled device to inform the remote controller of being unlocked after the first controlled device is unlocked.

18. The method for communication and control according to claim 12, wherein in the step of outputting the broadcast signal, output the broadcast signal to the first controlled device by the remote controller when the remote controller detects it is moved.

19. The method for communication and control according to claim 12, wherein in the step of outputting the lock signal and the control signal by the remote controller, after the first controlled device receives the lock signal and outputs a lock confirmation signal to the remote controller, output the control signal by the remote controller.
